(19) United States
(12) Patent Application Publication
(10) Pub. No.: US 2023/0098007 A1
(43) Pub. Date: Mar. 30, 2023

(54) VIBRATION DAMPING SYSTEM FOR AN AERIAL VEHICLE

(71) Applicant: Ziv Marom, San Francisco, CA (US)

(72) Inventor: Ziv Marom, San Francisco, CA (US)

(21) Appl. No.: 17/491,505

(22) Filed: Sep. 30, 2021

(51) Int. Cl. F16F 15/08; B64C 39/02

(52) U.S. Cl. CPC F16F 15/08; B64C 39/024; B64C 2201/00

(57) ABSTRACT

A vibration damping system (VDS) for an aerial vehicle carrying a payload is disclosed. The VDS comprises a vibration damping base plate, a vibration damping top plate, and a damping device mechanically coupled to both the vibration damping base plate and the vibration damping top plate. The vibration damping base plate is configured to be attached to the aerial vehicle and the vibration damping top plate is configured to be attached to the payload. The damping device includes a flexible damping material and the vibration damping base plate is physically isolated from the vibration damping top plate via the damping device.

### BACKGROUND

### 1. Field

The present disclosure is related to aerial vehicle systems that carry payloads below the aerial vehicle, and more specifically, to vibration damping systems for these aerial vehicles.

### 2. Related Art

At present, the use of unmanned aerial vehicles (UAVs) such as, for example, drones have become common place. Generally, these aerial vehicles fly through the air and experience general vibration and/or turbulence that causes vibration on the aerial vehicle. As more of these aerial vehicles are adapted to carry payloads such as, for example, packages, sensors, and still/video cameras, this vibration on the aerial vehicle is usually transferred to the payload that the aerial vehicle is carrying. If the payload is delicate such as, for example, in a fragile package or a camera system that needs a steady platform to properly capture or record a scene, any vibration from the aerial vehicle that is transferred to the payload may cause damage to the package or distortion or jiggle to any captured or recorded images or video of the scene. As such, there is a need for a system that reduces the amount of vibration on the payload from an aerial vehicle.

### SUMMARY

A vibration damping system (VDS) for an aerial vehicle carrying a payload is disclosed. The VDS comprises a vibration damping base plate, a vibration damping top plate, and a damping device mechanically coupled to both the vibration damping base plate and the vibration damping top plate. The vibration damping base plate is configured to be attached to the aerial vehicle and the vibration damping top plate is configured to be attached to the payload. The damping device includes a flexible damping material and the vibration damping base plate is physically isolated from the vibration damping top plate via the damping device.

In an example of operation, the VDS performs a method that comprises receiving a first vibration caused by the aerial vehicle at the vibration damping base plate attached to the aerial vehicle and damping the first vibration with the damping device mechanically coupled to the vibration damping base plate and the vibration damping top plate attached to the payload to produce a damped second vibration. The method further comprises passing the damped second vibration to the vibration damping top plate through the damping device.

Other devices, apparatuses, systems, methods, features, and advantages of the invention will be or will become apparent to one with skill in the art upon examination of the following figures and detailed description. It is intended that all such additional devices, apparatuses, systems, methods, features, and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a system block diagram of an example of an implementation of a vibration damping system (VDS) for use with an aerial vehicle and a payload in accordance with the present disclosure.

FIG. 2 is a top view of an example of an implementation of the VDS, shown in FIG. 1, in accordance with the present disclosure.

FIG. 3 is a bottom view of the example of the implementation of VDS, shown in FIGS. 1 and 2, in accordance with the present disclosure.

FIG. 4 is a perspective top view of the example of the implementation of VDS, shown in FIGS. 1-3, in accordance with the present disclosure.

FIG. 5 is a side view of the example of the implementation of VDS, shown in FIGS. 1-4, in accordance with the present disclosure.

FIG. 6 is a top view of an example of an implementation of a vibration damping base plate, shown in FIGS. 1-5, in accordance with the present disclosure.

FIG. 7 is a perspective top view of the vibration damping base plate, shown in FIGS. 1-6, in accordance with the present disclosure.

FIG. 8 is a side view of the vibration damping base plate, shown in FIGS. 1-7, in accordance with the present disclosure.

FIG. 9 is a top view of an example of an implementation of a vibration damping top plate, shown in FIGS. 1-8, in accordance with the present disclosure.

FIG. 10 is a perspective top view of the vibration damping top plate, shown in FIGS. 1-9, in accordance with the present disclosure.

FIG. 11 is a side view of the vibration damping top plate, shown in FIGS. 1-10, in accordance with the present disclosure.

FIG. 12 is a top view of an example of an implementation of a base damping member in accordance with the present disclosure.

FIG. 13 is a perspective top view of the base damping member in accordance with the present disclosure.

FIG. 14 is a top view of an example of an implementation of a top damping member in accordance with the present disclosure.

FIG. 15 is a perspective top view of the top damping member in accordance with the present disclosure

FIG. 16 is a top view of an example of an implementation of an assembly of the base damping member, shown in FIG. 12, top damping member, shown in FIG. 14, and a flexible damping material in the form of a plurality of rings in accordance with the present disclosure.

FIG. 17 is a top view of an example of an implementation of an assembly of the base damping member, shown in FIG. 12, top damping member, shown in FIG. 14, and a flexible damping material in the form of a plurality of balls in accordance with the present disclosure.

FIG. 18 is a top view of an example of another implementation of the VDS, shown in FIG. 1, in accordance with the present disclosure.

FIG. 19 is a perspective top view of the VDS, shown in FIGS. 1 and 18, in accordance with the present disclosure.

FIG. 20 is a side view of the VDS, shown in FIGS. 1, 18, and 19, in accordance with the present disclosure.

FIG. 21 is a top view of an example of another implementation of a vibration damping base plate, shown in FIGS. 18-20, in accordance with the present disclosure.

FIG. 22 is a perspective top view of the vibration damping base plate, shown in FIGS. 18-21, in accordance with the present disclosure.

FIG. 23 is a side view of the vibration damping base plate, shown in FIGS. 18-22, in accordance with the present disclosure.

FIG. 24 is a top view of an example of another implementation of a vibration damping top plate, shown in FIGS. 18-20, in accordance with the present disclosure.

FIG. 25 is a perspective top view of the vibration damping top plate, shown in FIGS. 18-24, in accordance with the present disclosure.

FIG. 26 is a side view of the vibration damping top plate, shown in FIGS. 18-25, in accordance with the present disclosure.

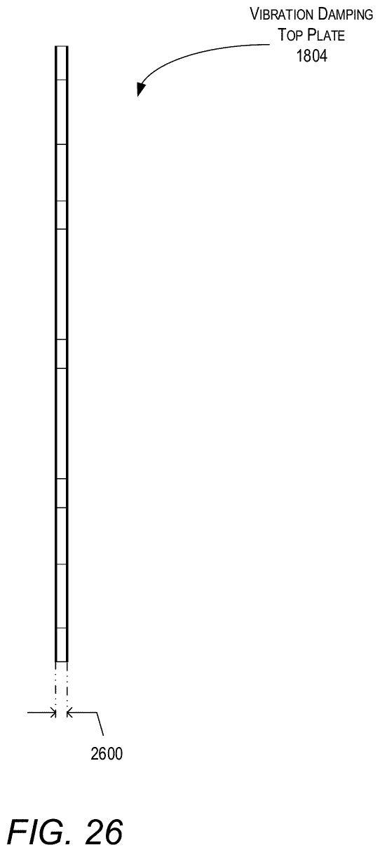

FIG. 27 is perspective top view of the VDS shown in FIGS. 1-5 including a plurality of quick release attachment devices connected to the vibration damping base plate in accordance with the present disclosure.

FIG. 28 is a flowchart of an example of an implementation of a method for the operation of the VDS, shown in FIGS. 1-5, 18-20, and 27, in accordance with the present disclosure.

### DETAILED DESCRIPTION

Disclosed is a vibration damping system (VDS) for an aerial vehicle carrying a payload. The VDS comprises a vibration damping base plate, a vibration damping top plate, and a damping device mechanically coupled to both the vibration damping base plate and the vibration damping top plate. The vibration damping base plate is configured to be attached to the aerial vehicle and the vibration damping top plate is configured to be attached to the payload. The damping device includes a flexible damping material and the vibration damping base plate is physically isolated from the vibration damping top plate via the damping device.

In an example of operation, the VDS performs a method that comprises receiving a first vibration caused by the aerial vehicle at the vibration damping base plate attached to the aerial vehicle and damping the first vibration with the damping device mechanically coupled to the vibration damping base plate and the vibration damping top plate attached to the payload to produce a damped second vibration. The method further comprises passing the damped second vibration to the vibration damping top plate through the damping device.

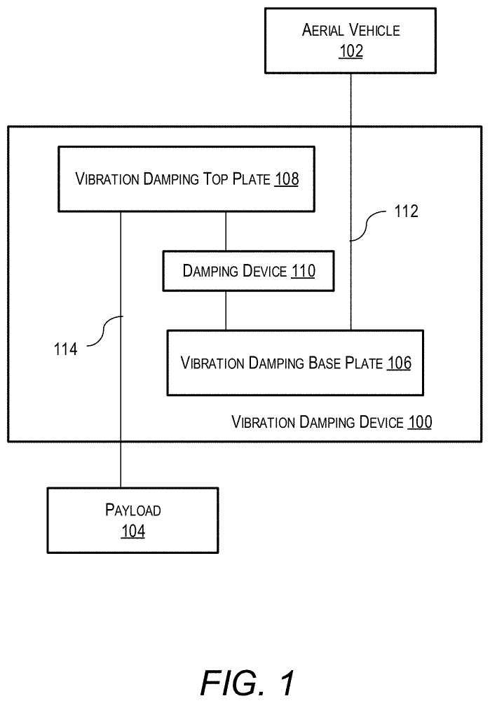

In FIG. 1, a system block diagram is shown of an example of an implementation of a VDS 100 for use with an aerial vehicle 102 and a payload 104 in accordance with the present disclosure. The VDS 100 comprises a vibration damping base plate 106, a vibration damping top plate 108, and a damping device 110. The vibration damping base plate 106 is configured to be attached to the aerial vehicle 102 and the vibration damping top plate 108 is configured to be attached to the payload 104. The damping device 110 is mechanically coupled to both the vibration damping base plate 106 and the vibration damping top plate 108. In this example, the vibration damping base plate 106 may be attached 112 to the aerial vehicle 102 via a mechanical coupler or other attachments means that include, for example, rods, screws, bolts, and nuts, attachment clips, or other similar mechanical elements. Additionally, in the example, the mechanical coupler includes one or more quick release attachment devices that releasably attach the vibration damping base plate 106 to the aerial vehicle 102 allowing the combination of the VDS 100 and the payload 104 to be detached from the aerial vehicle 102. Moreover, the one or more the quick release attachment devices may be servos that are configured to autonomously detach the combination of the VDS 100 and the payload 104 from the aerial vehicle 102. In this example, either the aerial vehicle 102 or the VDS 100 may include a controller that controls the operation of the servos of the quick release attachment devices.

Furthermore, in this example, the vibration damping top plate 108 may be attached 114 to the payload 104 via another mechanical coupler or other attachments means that include, for example, rods, screws, bolts, and nuts, attachment clips, or other similar mechanical elements. Similar to the vibration damping base plate 106, the mechanical coupler of the vibration damping top plate 108 may include one or more quick release attachment devices that releasably attach the vibration damping top plate 108 to the payload 104 allowing the combination of the VDS 100 and the aerial vehicle 102 to be detached from the payload 104. Moreover, the one or more the quick release attachment devices may also be servos that are configured to autonomously detach the combination of the VDS 100 and the aerial vehicle 102 from the payload 104. In this example, either the aerial vehicle 102, the VDS 100, or payload 104 may include a controller that controls the operation of the servos of the quick release attachment devices.

In this example, the damping device 110 includes a flexible damping material and the vibration damping base plate 106 is physically isolated from the vibration damping top plate 108 via the damping device 110. Moreover, in this example, the aerial vehicle 102 may be, for example, an airplane, a helicopter, a drone, or an unmanned autonomous vehicle (UAV) and the payload 104 maybe, for example, a package, a sensor, a scientific device, a still photo camera, a film movie camera, or a video camera.

Furthermore, in this example, the damping device 110 includes a base damping member physically attached to the vibration damping base plate 106 and a top damping member physically attached to the vibration damping top plate 108. The base damping member is physically adjacent to the top damping member and both the base damping member and the top damping member are partially surrounded by the flexible damping material.

In this example, the base damping member is a first rigid bar having a first end, a second end, a first passthrough opening proximate the first end of the first rigid bar, and a second passthrough opening proximate the second end of the first rigid bar. The top damping member is a second rigid bar having a first end and a second end. The base damping member is attached to the vibration damping base plate 106 at the first end of the first rigid bar and the second end of the first rigid bar and the top damping member is attached to the vibration damping top plate 108 at the first end of the second rigid bar and the second end of the second rigid bar. Furthermore, the first end of the second rigid bar is attached to the vibration damping top plate 108 through first passthrough opening of first rigid bar and the second end of the second rigid bar is attached to the vibration damping top plate 108 through second passthrough opening of first rigid bar. The first rigid bar and second rigid bar are surrounded by the flexible damping material between the first passthrough opening and the second passthrough opening. The flexible damping material may include a plurality of flexible rings or flexible balls, each having a passthrough orifice configured to freely pass the first rigid bar and the second rigid bar through each passthrough orifice.

In this example, a combination of the base damping member, top damping member, and flexible damping material are sandwiched between the vibration damping top plate 108 and the vibration damping base plate 106 and the combination is configured to dampen vibration between the vibration damping base plate 106 and the vibration damping top plate 108 through the base damping member and the top damping member of the damping device 110.

It is noted by those of ordinary skill in the art that in this example, the vibration damping top plate 108 pushes down on the vibration damping base plate 106 because the weight of the payload 104 is exerted directly on the vibration damping top plate 108 by the attachment means 114 that physically attaches the payload 104 to the vibration damping top plate 108.

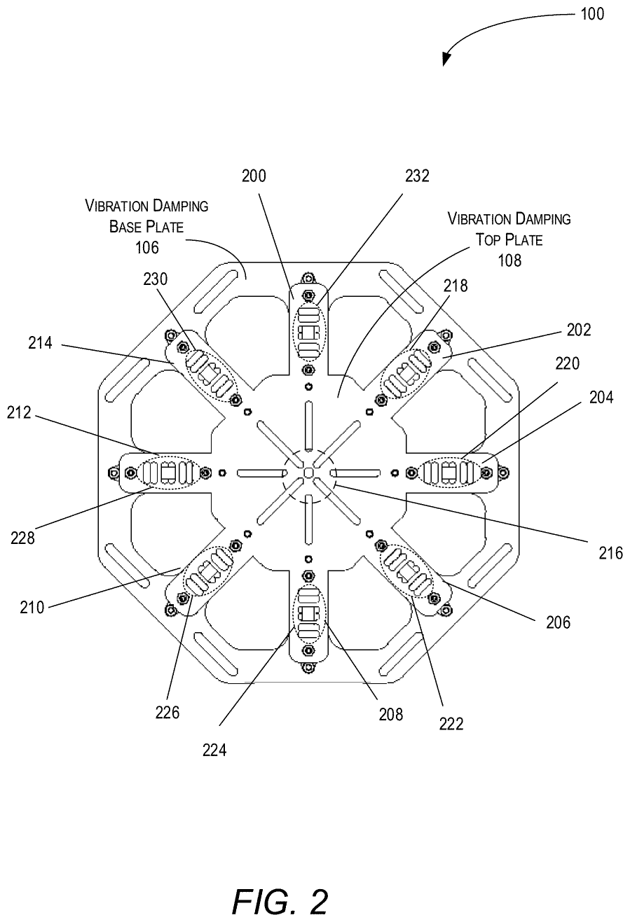

Turning to FIG. 2, a top view of an example of an implementation of the VDS 100 is shown in accordance with the present disclosure. In this example, the vibration damping top plate 108 includes a plurality of arms 200, 202, 204, 206, 208, 210, 212, and 214 that extend outward from a central portion 216 of the vibration damping top plate 108.

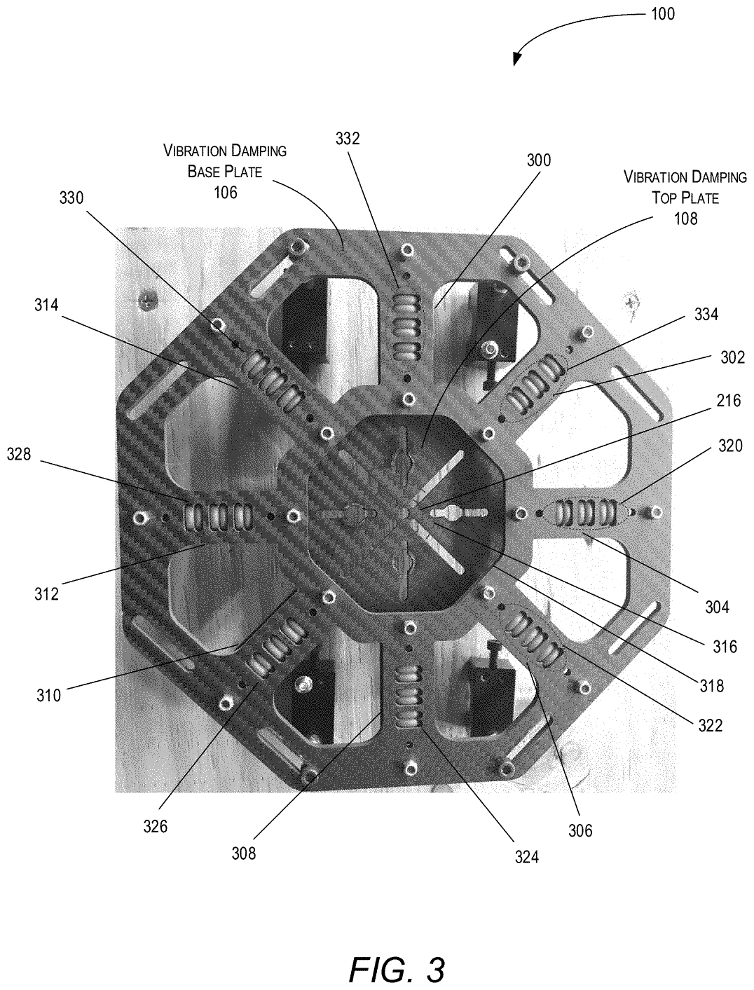

In FIG. 3, a bottom view of the example of the implementation of VDS 100 is shown in accordance with the present disclosure. In this example, the vibration damping base plate 106 includes a plurality of extending members 300, 302, 304, 306, 308, 310, 312, and 314 that extend from a central portion 316 of the vibration damping base plate 106. The vibration damping base plate 106 includes a passthrough orifice 318 in the central portion 316 of the vibration damping base plate 106, where the vibration damping top plate 108 is configured to be attached to the payload 104 through the passthrough orifice 318 of the vibration damping base plate 106 and the vibration damping top plate 108 presses down on the vibration damping base plate 106 when the vibration damping top plate 108 is attached to the payload 104.

In this example, the central portion 216 of the vibration damping top plate 108 is concentric with the central portion 316 of the vibration damping base plate 106, the vibration damping base plate 106 includes a first plurality of slots 320, 322, 324, 326, 328, 330, 332, and 334, and the vibration damping top plate 108 includes a second plurality of slots 218, 220, 222, 224, 226, 228, 230, and 232. The first plurality of slots 320, 322, 324, 326, 328, 330, 332, and 334 is configured to receive a first plurality of outer portions of the flexible damping material when the first rigid bar is attached to the vibration damping base plate 106, and the second plurality of slots 218, 220, 222, 224, 226, 228, 230, and 232 is configured to receive a second plurality of outer portions of the flexible damping material when the second rigid bar is attached to the vibration damping top plate 108.

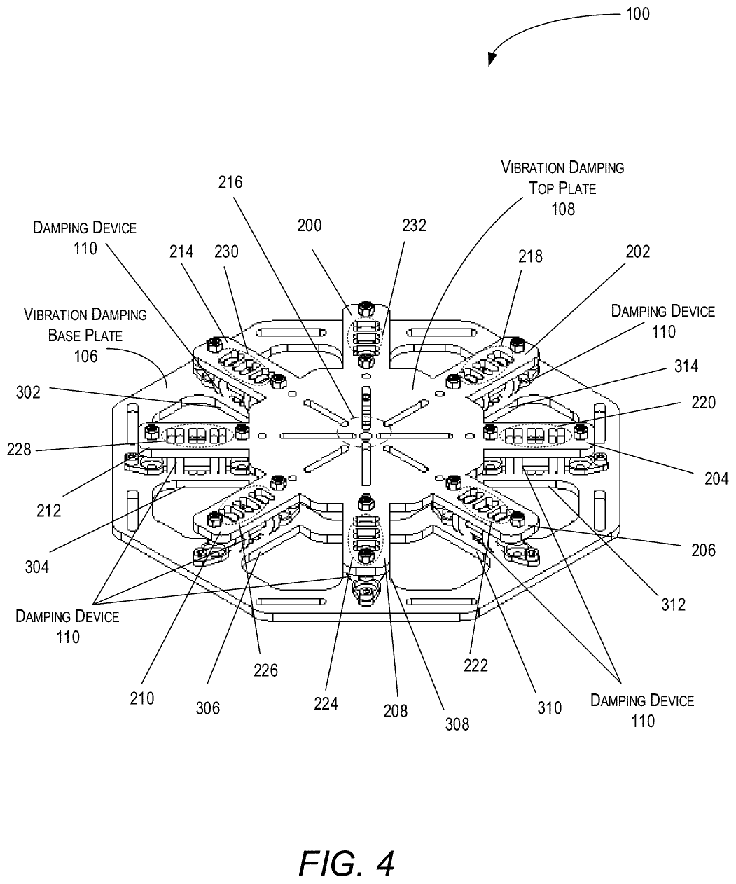

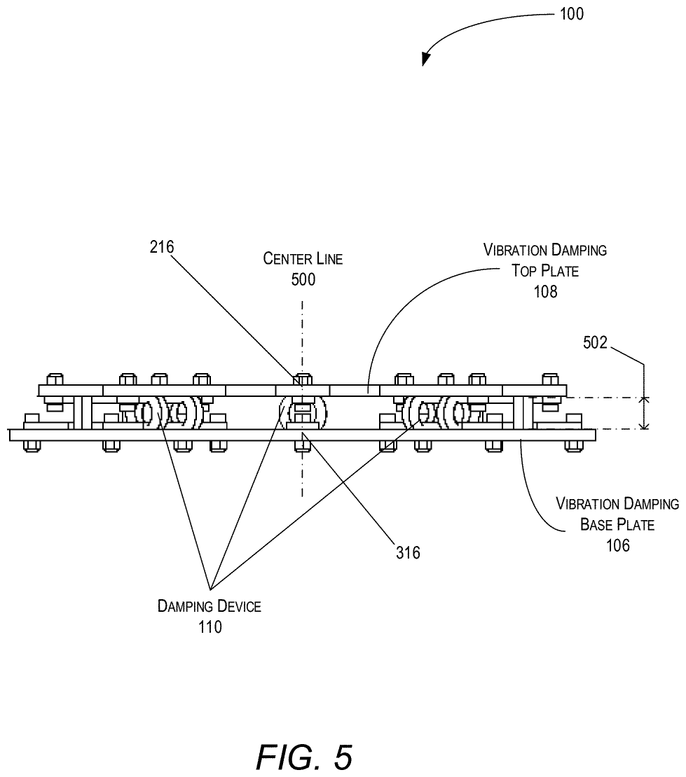

In FIG. 4, a perspective top view of the example of the implementation of VDS 100 is shown in accordance with the present disclosure. In FIG. 5, a side view of the example of the implementation of VDS 100 is shown in accordance with the present disclosure. In both of these figures, the damping device 110 is shown sandwiched between both the vibration damping base plate 106 and the vibration damping top plate 108. As discussed earlier, in operation, the vibration damping base plate 106 is attached 112 to the aerial vehicle 102 and the vibration damping top plate 108 is attached 114 to the payload 104 at the central portion 216 of the vibration damping top plate 108 through the passthrough orifice 318 in the central portion 316 of the vibration damping base plate 106. In this configuration, the weight of the payload 104 produces a downward force on the vibration damping top plate 108 that presses down on the surface of the vibration damping base plate 106 through the damping device 110. In this example, the vibration damping base plate 106 and the vibration damping top plate 108 may be spaced a distance 502 that is equal to approximately 12 millimeters.

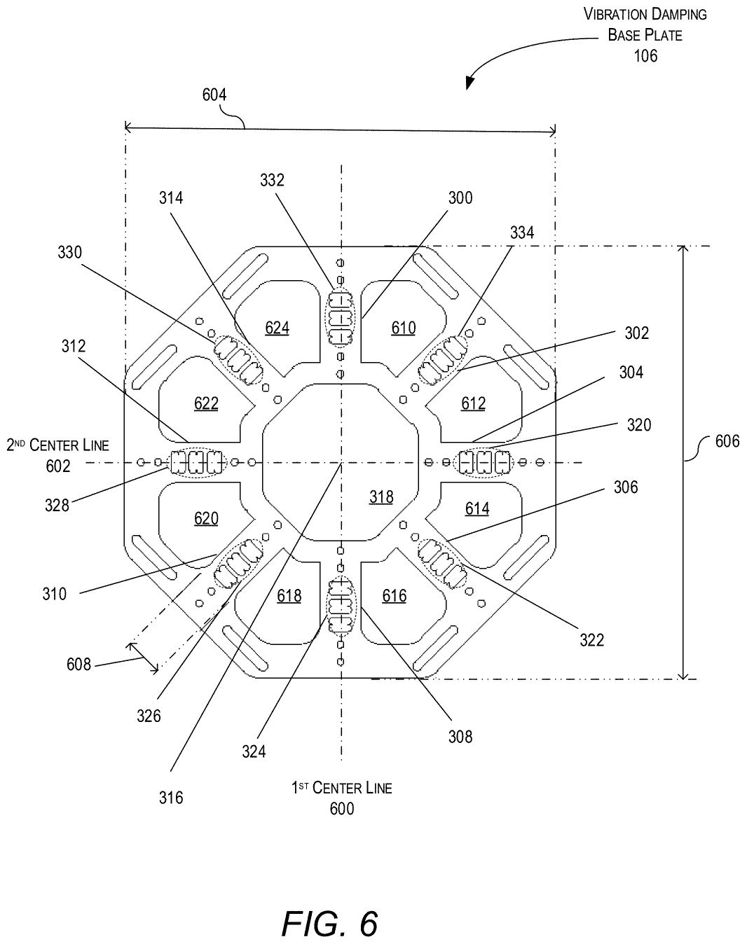

Turning to FIG. 6, a top view of an example of an implementation of the vibration damping base plate 106 is shown in accordance with the present disclosure. The vibration damping base plate 106 has a convex polygon shape that extends outward from the central portion 316 of the vibration damping base plate 106. In this example, the central portion 316 is shown as the intersection of a first centerline 600 and second centerline 602. The vibration damping base plate 106 may be constructed of a rigid material such as, for example, metal, plastic, wood, epoxy, ceramic, or other type of similar rigid material. The vibration damping base plate 106 has a width 604 and a length 606. In this example, the width 604 and length 606 may be equal to, for example, approximately 214 millimeters. Moreover, as discussed earlier, the vibration damping base plate 106 includes a plurality of extending members 300, 302, 304, 306, 308, 310, 312, and 314. As an example, the plurality of extending members may include at least four extending members 300, 304, 308, and 312 to dampen vibrations along both the first centerline 600, second centerline 602, and any in between angles. In this example, each extending member of the plurality of extending members 300, 302, 304, 306, 308, 310, 312, and 314 has an extending member width 608 that may be, for example, approximately 20 millimeters wide. Moreover, in this example, the vibration damping base plate 106 includes, for example, eight openings 610, 612, 614, 616, 618, 620, 622, and 624 that are adjacent to the corresponding extending members of the plurality of extending members 300, 302, 304, 306, 308, 310, 312, and 314. It is appreciated by those of ordinary skill in the art that they openings are optional and may be included for weight reduction.

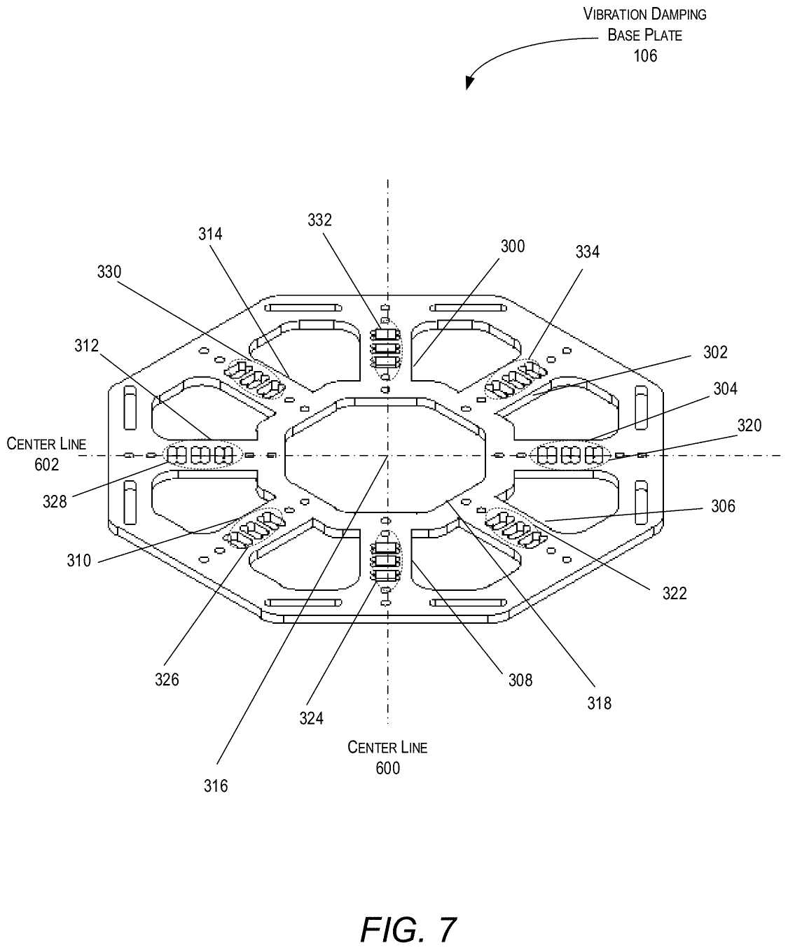

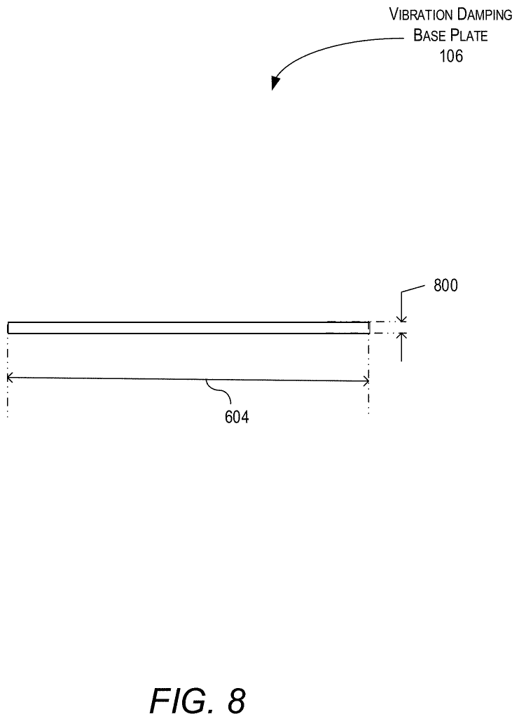

In FIG. 7 a perspective top view of the vibration damping base plate 106 is shown in accordance with the present disclosure and in FIG. 8, a side view of the vibration damping base plate 106 is shown in accordance with the present disclosure. In FIG. 8, the thickness 800 of the vibration damping base plate 106 may be, for example, approximately 4 millimeters.

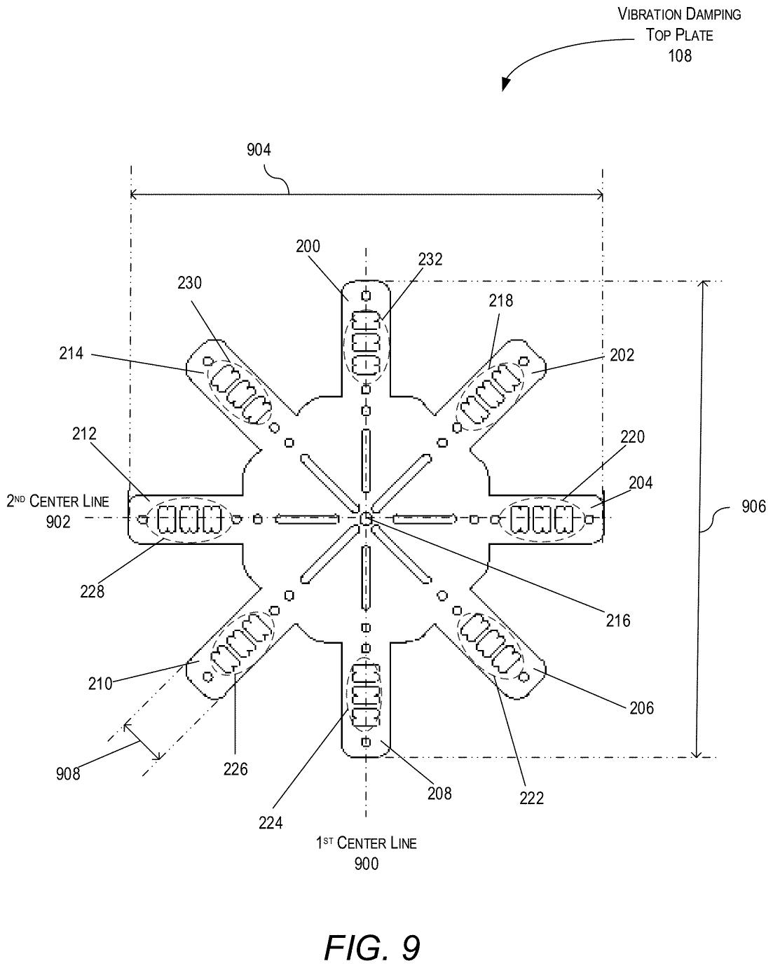

Turning to FIG. 9, a top view of an example of an implementation of the vibration damping top plate 108 is shown in accordance with the present disclosure. The vibration damping top plate 108 has a star-polygon shape that extends outward from the central portion 216 of the vibration damping top plate 108. In this example, the central portion 216 is shown as the intersection of a first centerline 900 and second centerline 902. The vibration damping top plate 108 may be constructed of a rigid material such as, for example, metal, plastic, wood, epoxy, ceramic, or other type of similar rigid material. The vibration damping top plate 108 has a width 904 and a length 906. In this example, the width 904 and length 906 may be equal to, for example, approximately 193 millimeters. Moreover, as discussed earlier, the vibration damping top plate 108 includes a plurality of arms 200, 202, 204, 206, 208, 210, 212, and 214 that extend outward from the central portion 216. As an example, the plurality of plurality of arms may include at least four arms 200, 204, 208, and 212 to dampen vibrations along both the first centerline 900, second centerline 902, and any in between angles. In this example, each arm of the plurality of arms 200, 202, 204, 206, 208, 210, 212, and 214 has an arm width 908 that may be, for example, approximately 20 millimeters wide.

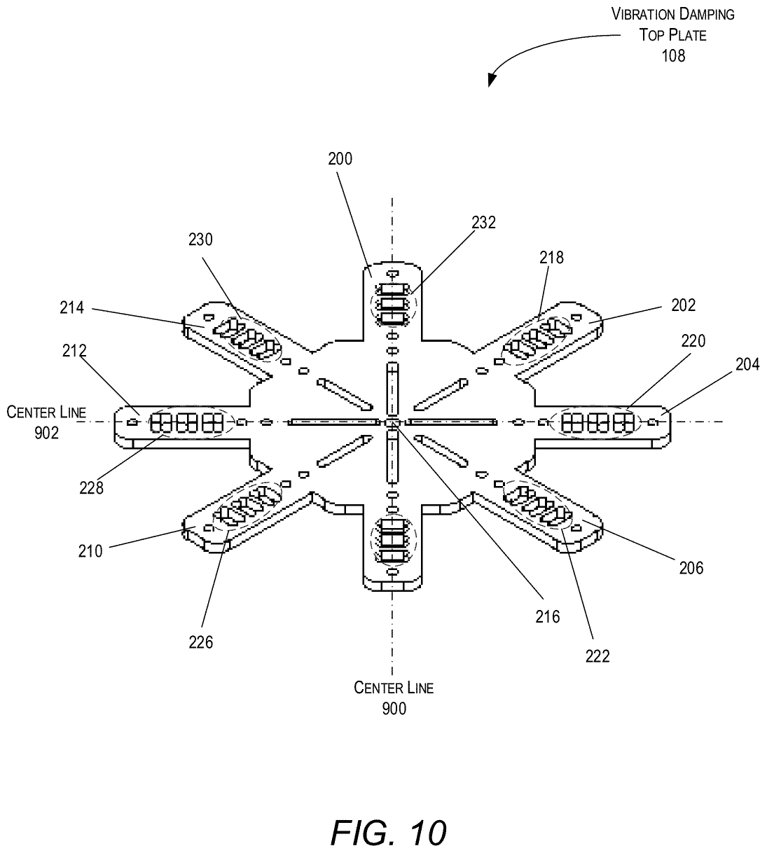

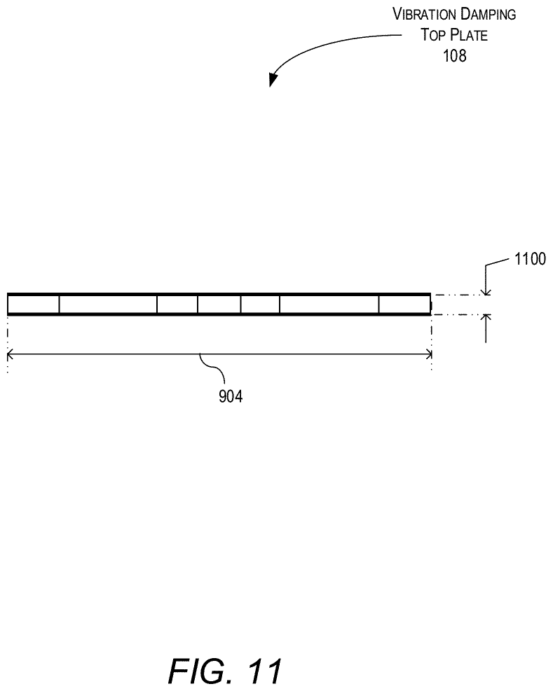

In FIG. 10, a perspective top view of the vibration damping top plate 108 is shown in accordance with the present disclosure and in FIG. 11, a side view of the vibration damping top plate 108 is shown in accordance with the present disclosure. In FIG. 11, the thickness 1100 of the vibration damping top plate 108 may be, for example, approximately 4 millimeters. In these examples, the central portion 216 of the vibration damping base plate 106 and central portion 316 of the vibration damping top plate 108 are concentric. Moreover, each extending member of the vibration damping base plate 106 corresponds to an arm of the vibration damping top plate 108.

As discussed earlier, the vibration damping base plate 106 includes a first plurality of slots 320, 322, 324, 326, 328, 330, 332, and 334 and the vibration damping top plate 108 includes a second plurality of slots 218, 220, 222, 224, 226, 228, 230, and 232. The first plurality of slots 320, 322, 324, 326, 328, 330, 332, and 334 is configured to receive the first plurality of outer portions of the flexible damping material when the first rigid bar is attached to the vibration damping base plate 106, and the second plurality of slots 218, 220, 222, 224, 226, 228, 230, and 232 is configured to receive the second plurality of outer portions of the flexible damping material when the second rigid bar is attached to the vibration damping top plate 108. The first plurality of slots and second plurality of slots may include enough slots to hold each outer portion of the first plurality of outer portions of the flexible damping material and each outer portion of the second plurality of outer portions of the flexible damping material or they may be less slots that hold a few of the outer portions of the flexible damping material. As an example, when the vibration damping base plate 106 and vibration damping top plate 108 are sandwiched together, if the flexible damping material includes a plurality of flexible rings, each slot of the first plurality of slots 320, 322, 324, 326, 328, 330, 332, and 334 and of the second plurality of slots 218, 220, 222, 224, 226, 228, 230, and 232 may be configured to hold the outer portion of a single flexible ring of the plurality of flexible rings. Alternatively, each slot of the first plurality of slots 320, 322, 324, 326, 328, 330, 332, and 334 and of the second plurality of slots 218, 220, 222, 224, 226, 228, 230, and 232 may be configured to hold the multiple flexible rings, for example, two flexible rings per slot.

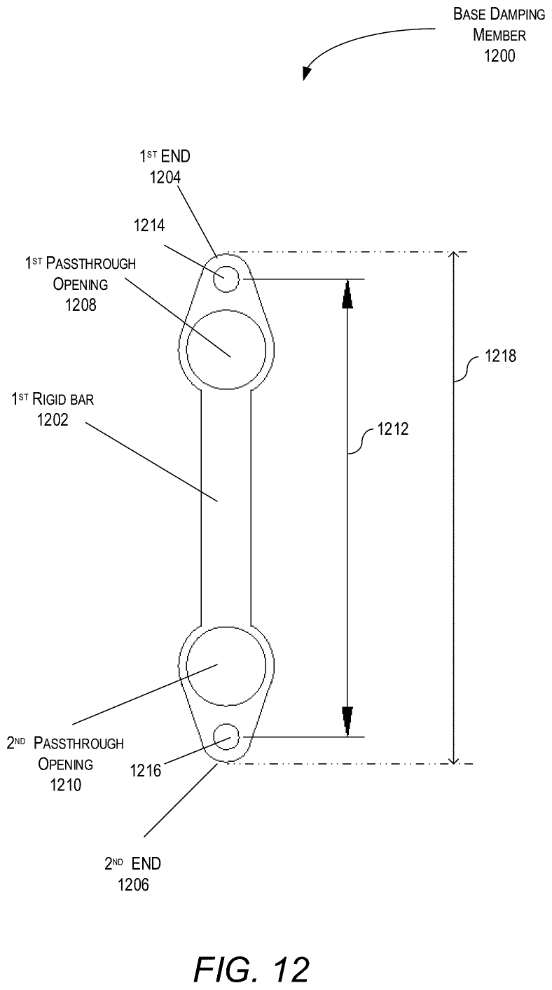

Turning to FIG. 12, a top view of an example of an implementation of a base damping member 1200 is shown in accordance with the present disclosure. The base damping member 1200 is configured to be physically attached to the vibration damping base plate 106. The base damping member 1200 is a first rigid bar 1202 having a first end 1204, a second end 1206, a first passthrough opening 1208 proximate the first end 1204 of the first rigid bar 1202, and a second passthrough opening 1210 proximate the second end 1206 of the first rigid bar 1202. The first rigid bar 1202 has a length 1212 between attachment holes 1214 and 1216 that may be attached to the vibration damping base plate 106 via attachment means such as, for example, bolts, screws, nuts, rivets, or other similar physical rigid attachment elements. In this example, the length 1212 may be, for example, approximately 55 millimeters. The total length 1218 of the first rigid bar 1202 may be, for example, approximately 61 millimeters.

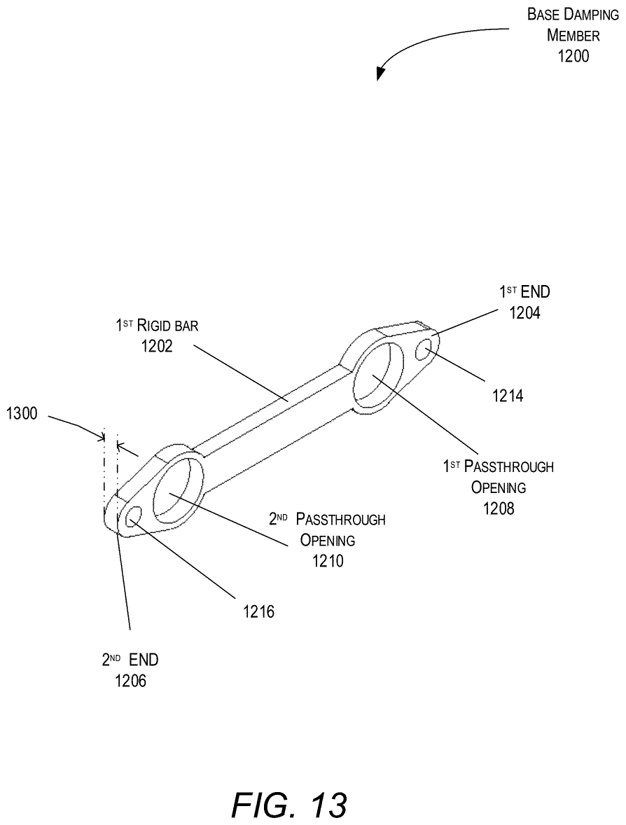

In FIG. 13, a perspective top view of the base damping member 1200 is shown in accordance with the present disclosure. In this example, the first rigid bar 1202 has a thickness 1300 that may be, for example, approximately 2.5 millimeters. The first rigid bar 1202 is constructed of, for example, metal, plastic, wood, ceramic, or other rigid material.

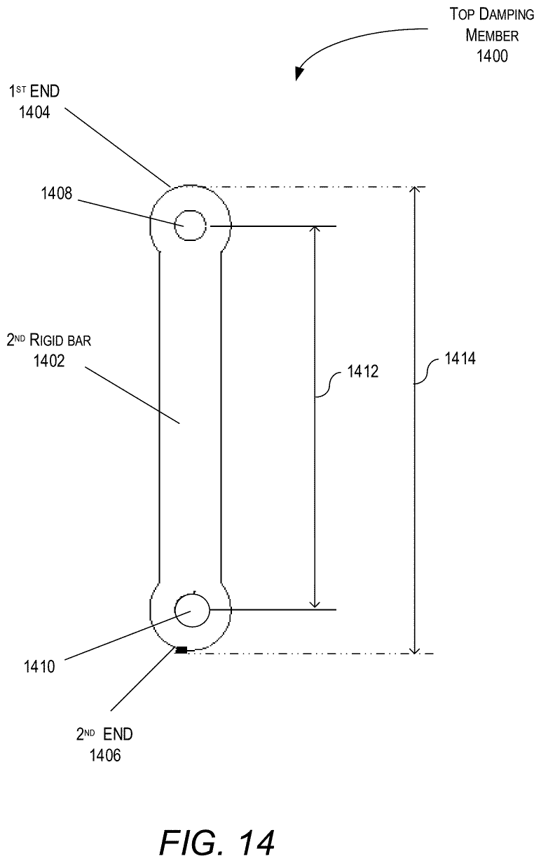

FIG. 14 is a top view of an example of an implementation of a top damping member 1400 in accordance with the present disclosure. The top damping member 1400 is configured to be physically attached to the vibration damping top plate 108. The top damping member 1400 is a second rigid bar 1402 having a first end 1404, a second end 1406, a first attachment hole 1408 proximate the first end 1404 of the second rigid bar 1402, and a second attachment hole 1410 proximate the second end 1406 of the second rigid bar 1402.

The second rigid bar 1402 has a length 1412 between attachment holes 1408 and 1410 that may be attached to the vibration damping top plate 108 via attachment means such as, for example, bolts, screws, nuts, rivets, or other similar physical rigid attachment elements. In this example, the length 1412 may be, for example, approximately 38 millimeters. The total length 1414 of the second rigid bar 1402 may be, for example, approximately 46 millimeters.

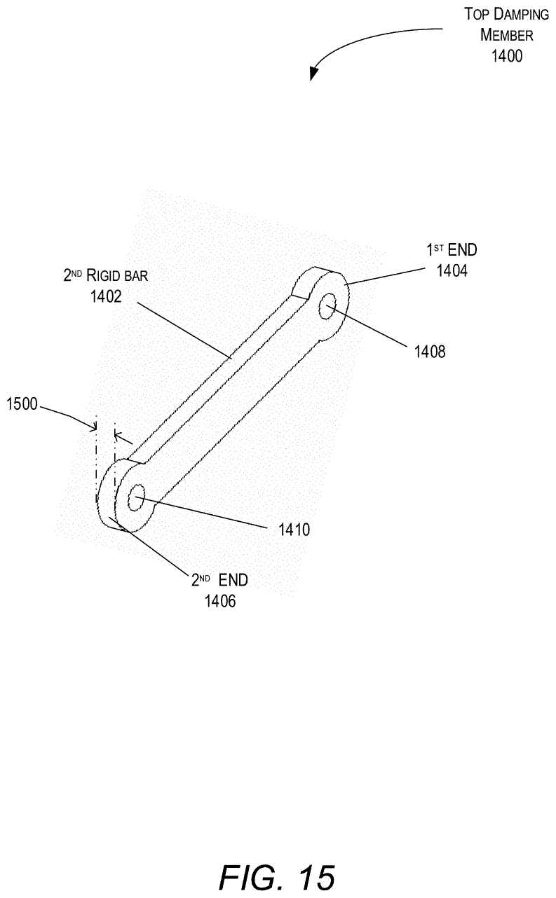

In FIG. 15, a perspective top view of the top damping member 1400 is shown in accordance with the present disclosure. In this example, the second rigid bar 1402 has a thickness 1500 that may be, for example, approximately 2.5 millimeters. The second rigid bar 1402 is constructed of, for example, metal, plastic, wood, ceramic, or other rigid material.

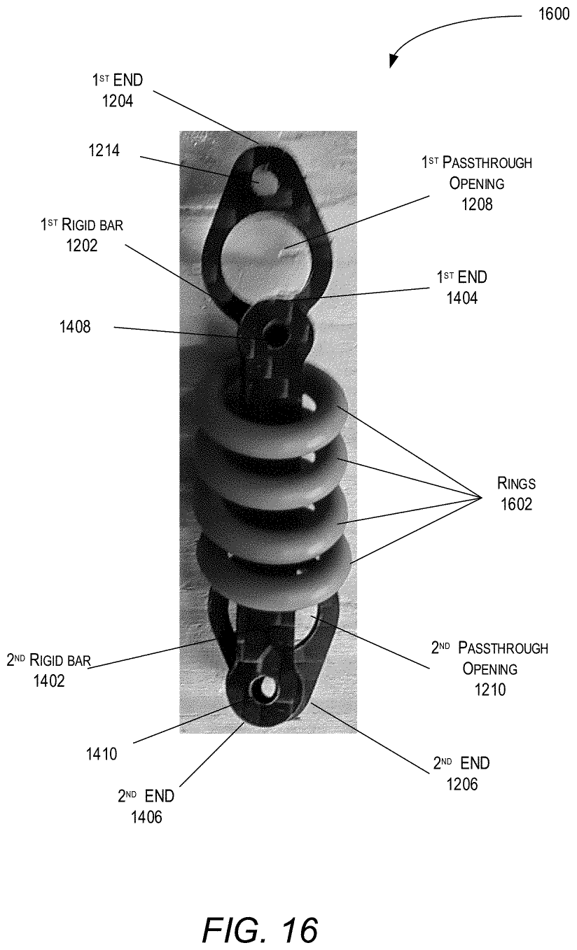

FIG. 16 is a top view of an example of an implementation of an assembly 1600 of the base damping member 1200, the top damping member 1400, and a flexible damping material in the form of a plurality of rings 1602 in accordance with the present disclosure. In this example, the base damping member 1200 (as the first rigid bar 1202) is physically adjacent to the top damping member 1400 (as the second rigid bar 1402) and both the base damping member 1200 and the top damping member 1400 are partially surrounded by the flexible damping material in the form of the plurality of rings 1602 that surround the base damping member 1200 between the first passthrough opening 1208 and second passthrough opening 1210 and top damping member 1400 between the first attachment hole 1408 and second attachment hole 1410.

In this example, the base damping member 1200 is attached to the vibration damping base plate 106 at the first end 1204 of the first rigid bar 1202 and the second end 1206 of the first rigid bar 1202. The top damping member 1400 is attached to the vibration damping top plate 108 at the first end 1404 of the second rigid bar 1402 and the second end 1406 of the second rigid bar 1402 via attachment means applied through the attachment holes 1408 and 1410. The first end 1404 of the second rigid bar 1402 is attached to the vibration damping top plate 108 through first passthrough opening 1208 of the first rigid bar 1202 and the second end 1406 of the second rigid bar 1402 is attached to the vibration damping top plate 108 through the second passthrough opening 1210 of first rigid bar 1202. Moreover, portions of the plurality of rings 1602 will be held in place in both the first plurality of slots 320, 322, 324, 326, 328, 330, 332, and 334 and of the second plurality of slots 218, 220, 222, 224, 226, 228, 230, and 232 when the vibration damping base plate 106 and the vibration damping top plate 108 are sandwiched together.

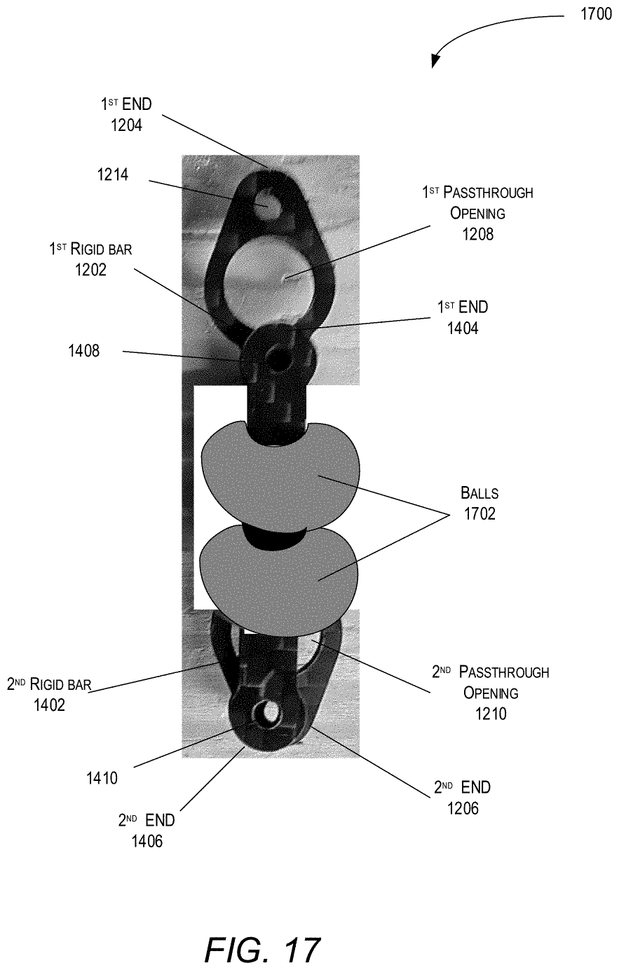

FIG. 17 is a top view of an example of an implementation of another assembly 1700 of the base damping member 1200, the top damping member 1400, and a flexible damping material in the form of a plurality of balls 1700 in accordance with the present disclosure. This is example is similar to the example shown in FIG. 16 except that instead of utilizing a plurality of rings 1602 for the flexible damping material, a plurality of balls 1700 is utilized.

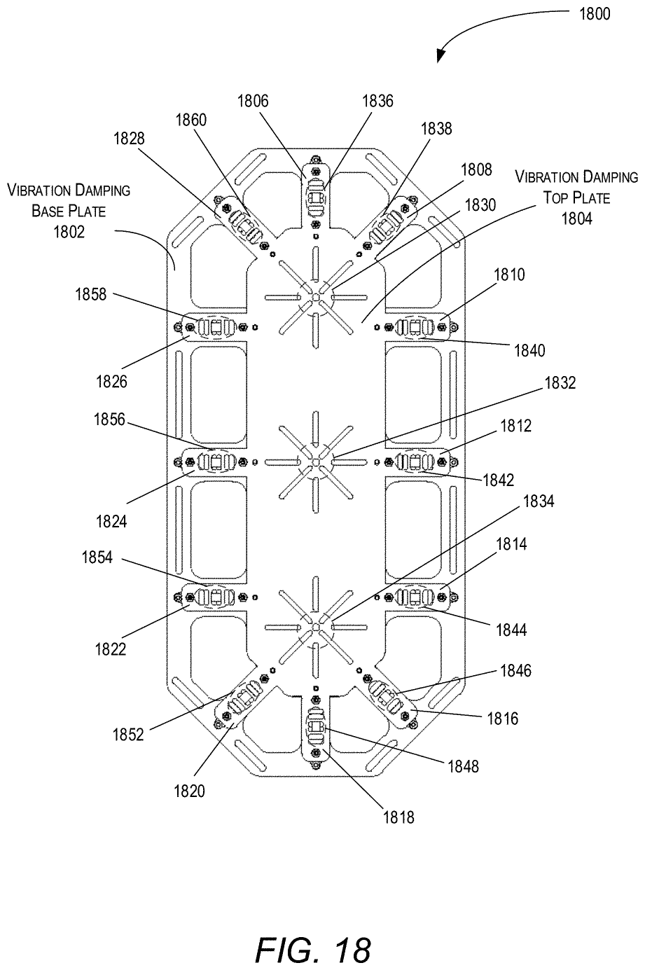

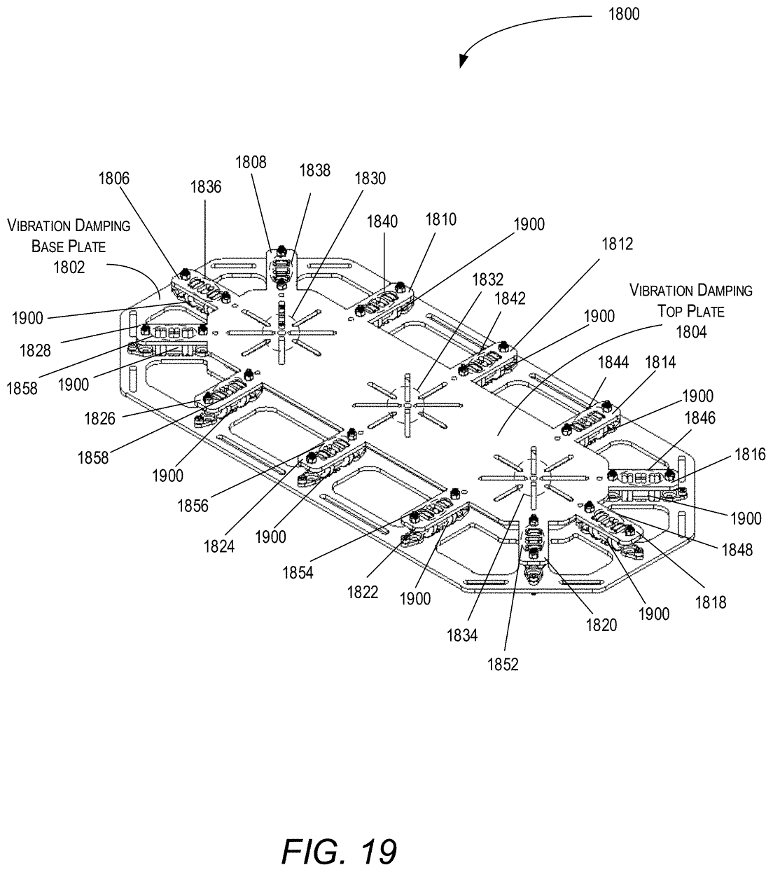

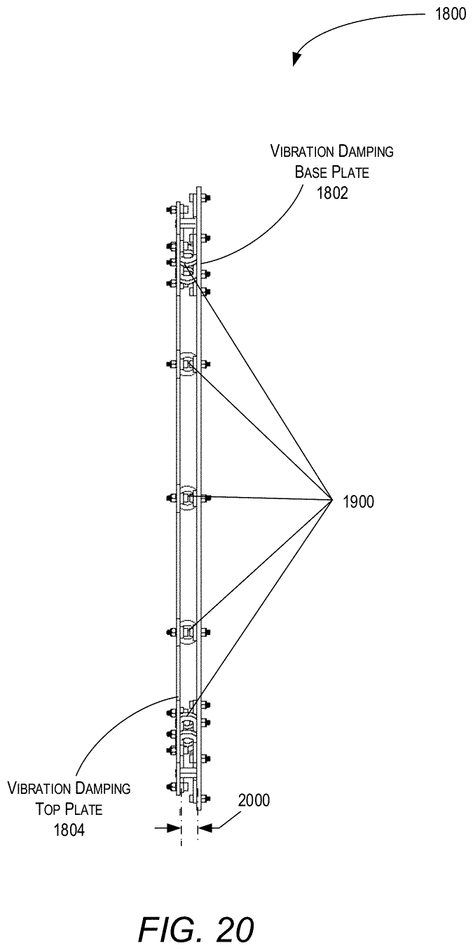

Turning to FIG. 18, a top view of an example of another implementation of the VDS 1800 is shown in accordance with the present disclosure. The VDS 1800 is similar to the VDS 100 described earlier except that width 604 and length 606 of the VDS 100 was approximately equal while the width 604 and length of the VDS 1800 is different because the length is greater than the width. As in the previous examples, the VDS 1800 includes a vibration damping base plate 1802, a vibration damping top plate 1804, and a damping device. In this example, the vibration damping top plate 1804 includes a plurality of arms 1806, 1808, 1810, 1812, 1814, 1816, 1818, 1820, 1822, 1824, 1826 and 1828 that extend outward from a plurality of central portions 1830, 1832, and 1834 of the vibration damping top plate 1804. In FIG. 19, a perspective top view of the VDS 1800 is shown in accordance with the present disclosure and FIG. 20 is a side view of the VDS 1800 is shown in accordance with the present disclosure. In both of these figures, the damping device 1900 is shown sandwiched between both the vibration damping base plate 1802 and the vibration damping top plate 1804. As discussed earlier, in operation, the vibration damping base plate 1802 is attached 112 to the aerial vehicle 102 and the vibration damping top plate 1804 is attached 114 to the payload 104 at either the central portion 1830, 1832, or 1834 of the vibration damping top plate 1804 through the passthrough orifice of the vibration damping base plate 1802. In this configuration, as in the previous example, the weight of the payload 104 produces a downward force on the vibration damping top plate 1804 that presses down on the surface of the vibration damping base plate 1802 through the damping device 1900. In this example, the vibration damping base plate 1802 and the vibration damping top plate 1804 may be spaced a distance 2000 that is equal to approximately 12 millimeters.

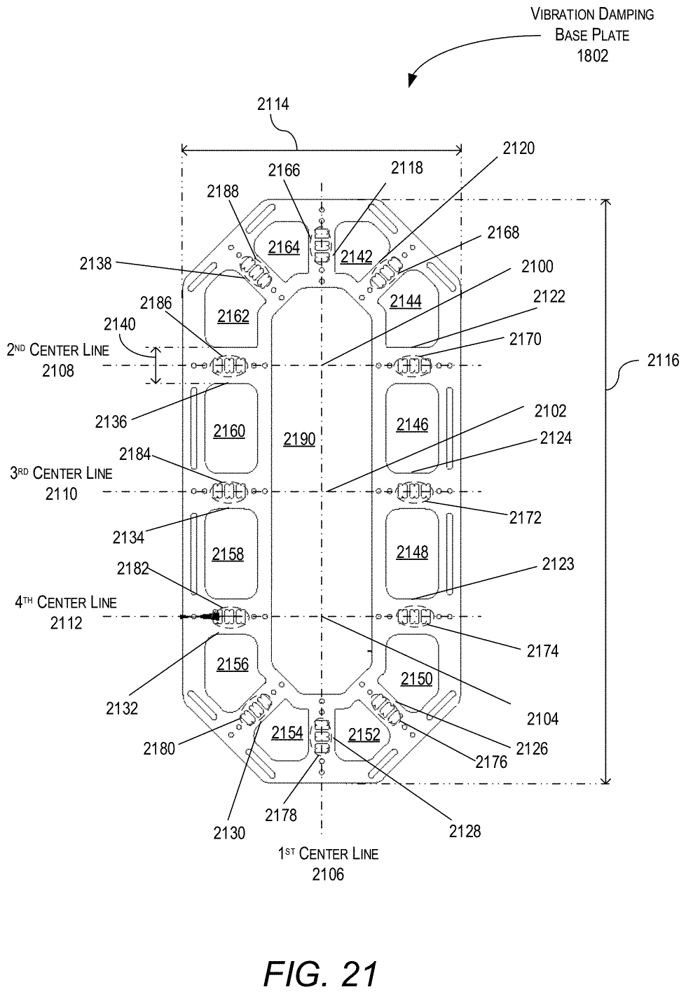

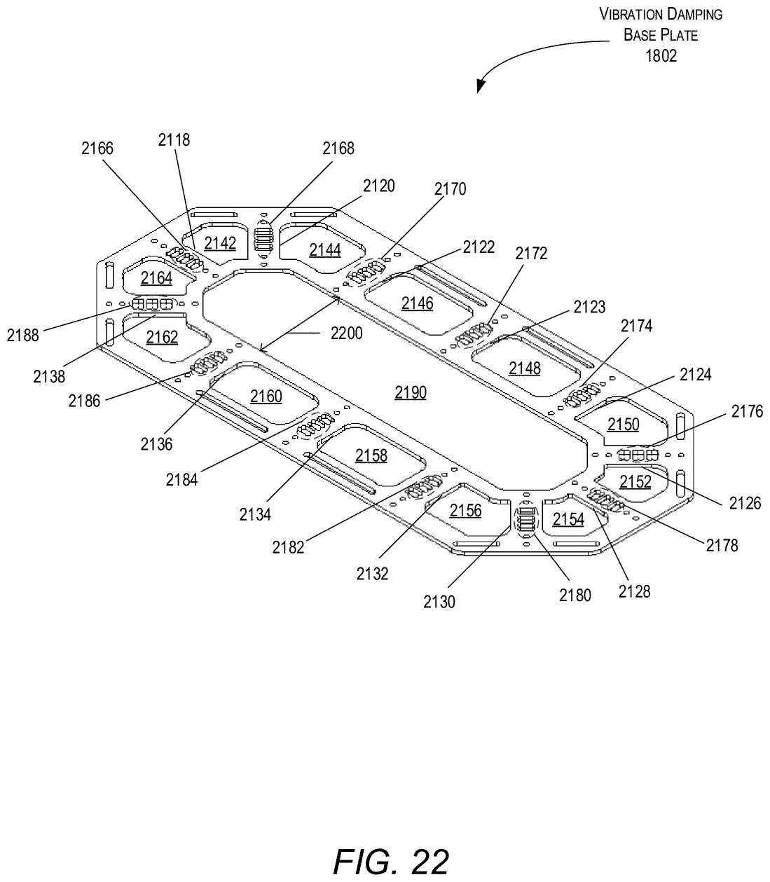

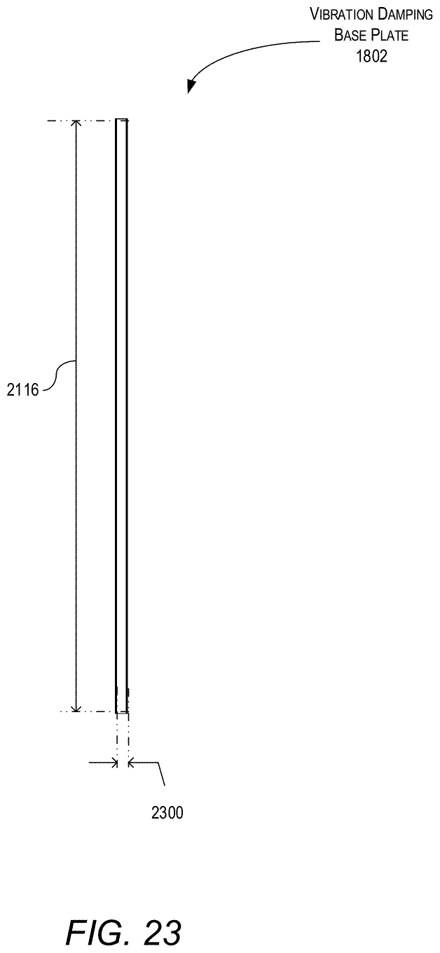

In FIG. 21, a top view of an example of an implementation of the vibration damping base plate 1802 in accordance with the present disclosure. FIG. 22 is a perspective top view of the vibration damping base plate 1802 in accordance with the present disclosure and FIG. 23 is a side view of the vibration damping base plate 1802 in accordance with the present disclosure. The vibration damping base plate 1802 has a convex polygon shape that extends outward from a plurality of central portions 2100, 2102, and 2104 of the vibration damping base plate 106. In this example, the first central portion 2100 is shown as the intersection of a first centerline 2106 and a second centerline 2108. The second central portion 2102 is shown as the intersection of the first centerline 2106 and a third centerline 2110 and the third central portion 2104 is shown as the intersection of the first centerline 2106 and a fourth centerline 2112. The vibration damping base plate 1802 may be constructed of a rigid material such as, for example, metal, plastic, wood, epoxy, ceramic, or other type of similar rigid material. The vibration damping base plate 1802 has a width 2114 and a length 2116. Unlike the previous example, in this example, the width 2114 and length 2116 are not equal. In this example, the width 2114 may be equal to approximately 214 millimeters and the length may be equal to approximately 450 millimeters. Moreover, as discussed earlier, the vibration damping base plate 106 includes a plurality of extending members 2118, 2120, 2122, 2124, 2126, 2128, 2130, 2132, 2134, 2136, and 2138. In this example, each extending member of the plurality of extending members 2118, 2120, 2122, 2123, 2124, 2126, 2128, 2130, 2132, 2134, 2136, and 2138 has an extending member width 2140 that may be, for example, approximately 20 millimeters wide. Moreover, in this example, the vibration damping base plate 1802 includes, for example, twelve openings 2142, 2144, 2146, 2148, 2150, 2152, 2154, 2156, 2158, 2160, 2162, and 2164 that are adjacent to the corresponding extending members of the plurality of extending members 2118, 2120, 2122, 2123, 2124, 2126, 2128, 2130, 2132, 2134, 2136, and 2138. It is appreciated by those of ordinary skill in the art that they openings are optional and may be included for weight reduction. In this example, the thickness 2300 of the vibration damping base plate 1802 may be, for example, approximately 3 millimeters.

In this example, the vibration damping base plate 1802 includes a first plurality of slots 2166, 2168, 2170, 2172, 2174, 2176, 2178, 2180, 2182, 2184, 2186, and 2188 and the vibration damping top plate 1804 includes a second plurality of slots 1836, 1838, 1840, 1842, 1844, 1846, 1848, 1850, 1852, 1854, 1856, 1858, and 1860. The first plurality of slots 2166, 2168, 2170, 2172, 2174, 2176, 2178, 2180, 2182, 2184, 2186, and 2188 is configured to receive a first plurality of outer portions of the flexible damping material when the first rigid bar is attached to the vibration damping base plate 1802, and the second plurality of slots 1836, 1838, 1840, 1842, 1844, 1846, 1848, 1852, 1854, 1856, 1858, and 1860 is configured to receive a second plurality of outer portions of the flexible damping material when the second rigid bar is attached to the vibration damping top plate 1804. In this example, the vibration damping base plate 1802 also includes a passthrough orifice 2190 in the plurality central portions 2100, 2102, and 2104. The passthrough orifice 2190 may have a width 2200 of approximately 77 millimeters.

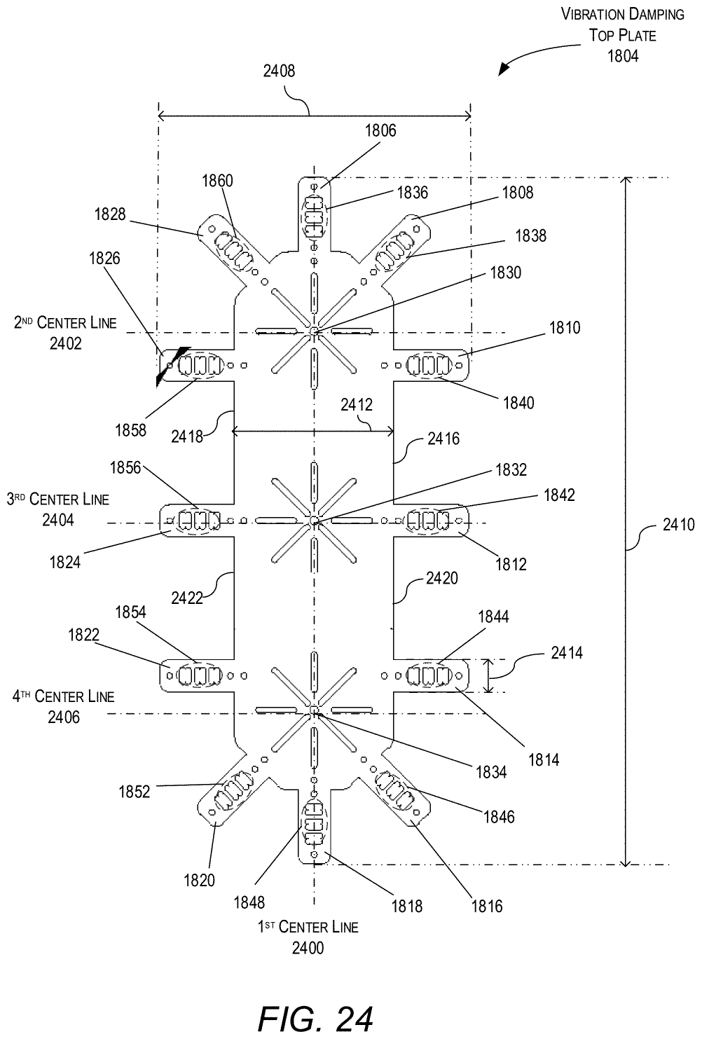

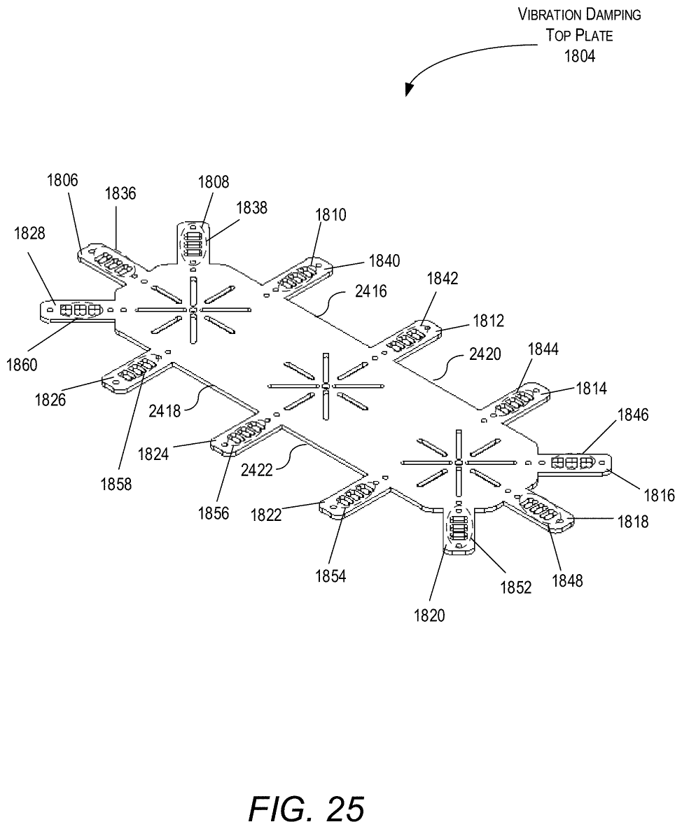

Turning to FIG. 24, a top view of an example of the implementation of the vibration damping top plate 1804 is shown in accordance with the present disclosure. In FIG. 25, a perspective top view of the vibration damping top plate 1804 is shown and in FIG. 16 a side view of the vibration damping top plate 1804 is shown in accordance with the present disclosure.

The vibration damping top plate 1804 has an extended star-polygon shape that extends outward from the central portion 1830, 1832, and 1834 of the vibration damping top plate 1804. In this example, the first central portion 1830 is shown as the intersection of a first centerline 2400 and a second centerline 2402. The second central portion 1832 is shown as the intersection of the first centerline 2400 and a third centerline 2404 and the third central portion 1834 is shown as the intersection of the first centerline 2400 and a fourth centerline 2406. The vibration damping top plate 1804 may be constructed of a rigid material such as, for example, metal, plastic, wood, epoxy, ceramic, or other type of similar rigid material. The vibration damping top plate 1804 has a width 2408 and a length 2410. In this example, the width 2408 and a length 2410 are not equal. The width 2408 may be, for example, approximately 193 millimeters and the length may be, for example, approximately 429 millimeters. The vibration damping top plate 1804 may also have an internal width 2412 that is equal to, for example, approximately 99 millimeters.

Moreover, as discussed earlier, the vibration damping top plate 1804 includes a plurality of arms 1806, 1808, 1810, 1812, 1814, 1816, 1818, 1820, 1822, 1824, 1826 and 1828 that extend outward from the central portions 1830, 1832, and 1834. In this example, each arm of the plurality of arms 1806, 1808, 1810, 1812, 1814, 1816, 1818, 1820, 1822, 1824, 1826 and 1828 has an arm width 2414 that may be, for example, approximately 20 millimeters wide. The thickness 2600 of the vibration damping top plate 1804 may be, for example, approximately 3 millimeters.

As an example, the arms 1828, 1806, and 1808 may extend out radially from the first center portion 1830 at, for example, approximately 45 degrees. Similarly, the arms 1816, 1818, and 1820 may extend out radially from the third center portion 1834 at, for example, approximately 45 degrees. The arms 1810 and 1826 may extend out normally from the inner edges 2416 and 2418 below the second centerline 2402, where arm 1810 is approximately at 45 degrees from arm 1808 and arm 1826 is approximately 45 degrees from arm 1828. Similarly, arms 1814 and 1822 may extend out normally from the inner edges 2420 and 2422 above the fourth centerline 2406, where arm 1814 is approximately at 45 degrees from arm 1816 and arm 1822 is approximately 45 degrees from arm 1820. Moreover, arm 1812 extends out normally from the inner edges 2416 and 2420 along the third centerline 2402 and arm 1824 extends out normally from the inner edges 2418 and 2422 along the third centerline 2402.

In these examples, the central portions 2100, 2102, and 2104 of the vibration damping base plate 1802 and the central portions 1830, 1832, and 1834 of the vibration damping top plate 1804 are concentric. Moreover, each extending member of the vibration damping base plate 1802 corresponds to an arm of the vibration damping top plate 1804.

As discussed earlier, the vibration damping base plate 1802 includes a first plurality of slots 2166, 2168, 2170, 2172, 2174, 2176, 2178, 2180, 2182, 2184, 2186, and 2188 and the vibration damping top plate 1804 includes a second plurality of slots 1836, 1838, 1840, 1842, 1844, 1846, 1848, 1850, 1852, 1854, 1856, 1858, and 1860. The first plurality of slots 2166, 2168, 2170, 2172, 2174, 2176, 2178, 2180, 2182, 2184, 2186, and 2188 is configured to receive the first plurality of outer portions of the flexible damping material when the first rigid bar is attached to the vibration damping base plate 1802, and the second plurality of slots 1836, 1838, 1840, 1842, 1844, 1846, 1848, 1850, 1852, 1854, 1856, 1858, and 1860 is configured to receive the second plurality of outer portions of the flexible damping material when the second rigid bar is attached to the vibration damping top plate 1804.

The first plurality of slots and second plurality of slots may include enough slots to hold each outer portion of the first plurality of outer portions of the flexible damping material and each outer portion of the second plurality of outer portions of the flexible damping material or they may be less slots that hold a few of the outer portions of the flexible damping material. As an example, when the vibration damping base plate 1802 and vibration damping top plate 1804 are sandwiched together, if the flexible damping material includes a plurality of flexible rings, each slot of the first plurality of slots 2166, 2168, 2170, 2172, 2174, 2176, 2178, 2180, 2182, 2184, 2186, and 2188 and of the second plurality of slots 1836, 1838, 1840, 1842, 1844, 1846, 1848, 1850, 1852, 1854, 1856, 1858, and 1860 may be configured to hold the outer portion of a single flexible ring of the plurality of flexible rings. Alternatively, each slot of the first plurality of slots 2166, 2168, 2170, 2172, 2174, 2176, 2178, 2180, 2182, 2184, 2186, and 2188 and of the second plurality of slots 1836, 1838, 1840, 1842, 1844, 1846, 1848, 1850, 1852, 1854, 1856, 1858, and 1860 may be configured to hold the multiple flexible rings, for example, two flexible rings per slot.

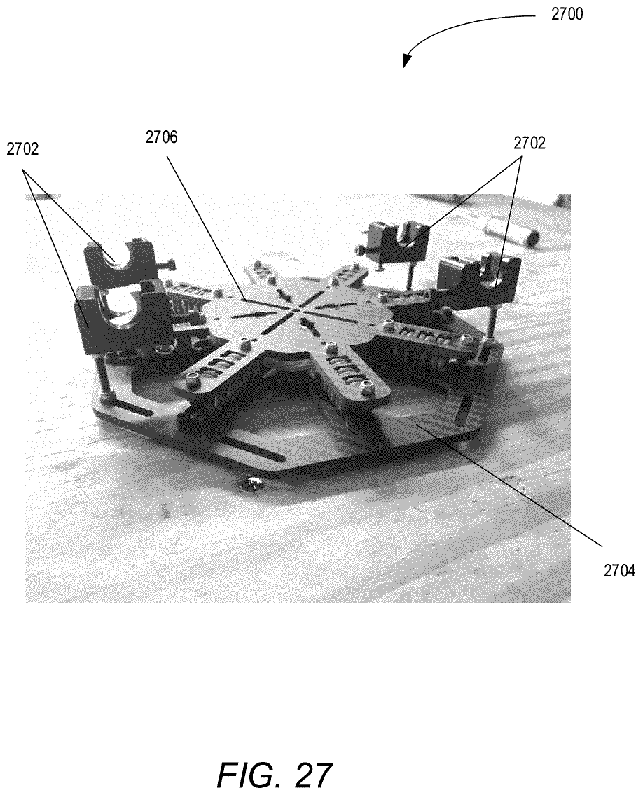

Turning to FIG. 27, a perspective top view of the VDS 2700 is shown including a plurality of quick release attachment devices 2702 connected to the vibration damping base plate 2704 in accordance with the present disclosure. In this example, the quick release attachment devices 2702 that releasably attach the vibration damping base plate 2704 to the aerial vehicle 102 allowing the combination of the VDS 2700 and the payload 104 to be detached from the aerial vehicle 102. The quick release attachment devices 2702 may include servos or other remote controlled releasable attachment devices. They may be controlled by a remote user of the aerial vehicle 102 or autonomously by the aerial vehicle 102 and/or the payload 104. In this example, the VDS 2700 may also include another plurality of quick release attachment devices (not shown) that is connected to the vibration damping top plate 2706 and hangs through the opening in the vibration damping base plate 2704 to attach to the payload 104. In this example, the payload 104 may be remotely or autonomously detached from the combination of the VDS 2700 and aerial vehicle 102.

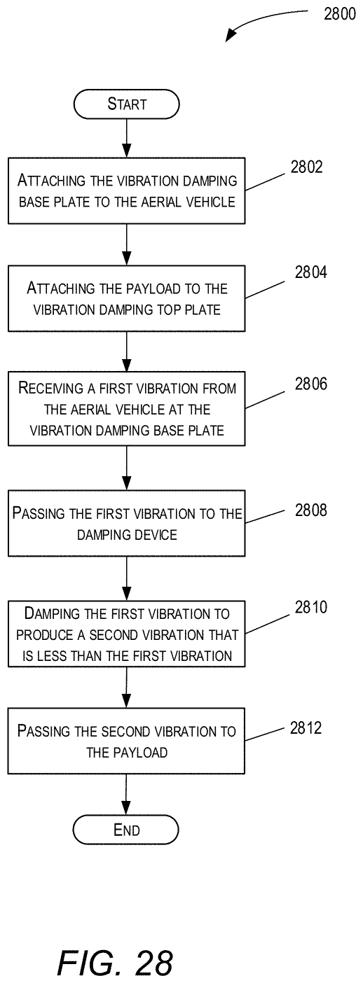

FIG. 28 is a flowchart of an example of an implementation of a method 2800 for the operation of the VDS 100, 1800, or 2700 in accordance with the present disclosure. The method 2800 includes attaching 2802 the vibration damping base plate 106, 1802, or 2704 of the VDS 100, 1800, or 2700 to the aerial vehicle 102 and attaching 2804 the payload 104 to the vibration damping top plate 108, 1804, or 2706 of the VDS 100, 1800, or 2700.

In operation, the aerial vehicle 102 experiences vibrations and/or turbulence as the combination of the aerial vehicle 102, VDS 100, 1800, or 2700, and payload 104 flies through the aerial environment. A first vibration from the aerial vehicle 102 is received 2806 at the vibration damping base plate 106, 1802, or 2704. The first vibration is then passed 2808 to the damping device 110 or 1900. The damping device 110 or 1900 then damps 2810 the first vibration passing the first vibration to the base damping member 1200 physically attached to the vibration damping base plate 106, 1802, or 2704 that is adjacent to the top damping member 1400 while being surrounded by the flexible damping material (e.g., rings 1602 or balls 1700). This produces a smaller second vibration on the top damping member that is passed to the vibration damping top plate 108, 1804, or 2706. The second vibration is then passed 2812 to the payload 104 and the method ends.

It will be understood that various aspects or details of the disclosure may be changed without departing from the scope of the disclosure. It is not exhaustive and does not limit the claimed disclosures to the precise form disclosed. Furthermore, the foregoing description is for the purpose of illustration only, and not for the purpose of limitation. Modifications and variations are possible in light of the above description or may be acquired from practicing the disclosure. The claims and their equivalents define the scope of the disclosure. Moreover, although the techniques have been described in language specific to structural features and/or methodological acts, it is to be understood that the appended claims are not necessarily limited to the features or acts described. Rather, the features and acts are described as an example implementations of such techniques.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Furthermore, the description of the different examples of implementations has been presented for purposes of illustration and description, and is not intended to be exhaustive or limited to the examples in the form disclosed. Many modifications and variations will be apparent to those of ordinary skill in the art. Further, different examples of implementations may provide different features as compared to other desirable examples. The example, or examples, selected are chosen and described in order to best explain the principles of the examples, the practical application, and to enable others of ordinary skill in the art to understand the disclosure for various examples with various modifications as are suited to the particular use contemplated.

It will also be understood that various aspects or details of the invention may be changed without departing from the scope of the invention. It is not exhaustive and does not limit the claimed inventions to the precise form disclosed. Furthermore, the foregoing description is for the purpose of illustration only, and not for the purpose of limitation. Modifications and variations are possible in light of the above description or may be acquired from practicing the invention. The claims and their equivalents define the scope of the invention.

The description of the different examples of implementations has been presented for purposes of illustration and description, and is not intended to be exhaustive or limited to the examples in the form disclosed. Many modifications and variations will be apparent to those of ordinary skill in the art. Further, different examples of implementations may provide different features as compared to other desirable examples. The example, or examples, selected are chosen and described in order to best explain the principles of the examples, the practical application, and to enable others of ordinary skill in the art to understand the disclosure for various examples with various modifications as are suited to the particular use contemplated.

What is claimed is:

1. A drone having a vibration damping system (VDS), the drone comprising:
a vibration damping base plate configured to attach to the drone;
a vibration damping top plate configured to attach to a payload; and
a damping device mechanically coupled to both the vibration damping base plate and the vibration damping top plate,
wherein
the damping device includes a flexible damping material and
the vibration damping base plate is physically isolated from the vibration damping top plate via the damping device.

2. A vibration damping system (VDS) for an aerial vehicle carrying a payload, the VDS comprising:
a vibration damping base plate configured to be attached to the aerial vehicle;
a vibration damping top plate configured to be attached to the payload; and
a damping device mechanically coupled to both the vibration damping base plate and the vibration damping top plate,
wherein
the damping device includes a flexible damping material and
the vibration damping base plate is physically isolated from the vibration damping top plate via the damping device.

3. The VDS of claim 2,
wherein the damping device includes
a base damping member physically attached to the vibration damping base plate and
a top damping member physically attached to the vibration damping top plate,
wherein
the base damping member is physically adjacent to the top damping member and
both the base damping member and the top damping member are partially surrounded by the flexible damping material.

4. The VDS of claim 3, wherein
the base damping member is a first rigid bar having a first end, a second end, a first passthrough opening proximate the first end of the first rigid bar, and a second passthrough opening proximate the second end of the first rigid bar,
the top damping member is a second rigid bar having a first end and a second end,
the base damping member is attached to the vibration damping base plate at the first end of the first rigid bar and the second end of the first rigid bar,
the top damping member is attached to the vibration damping top plate at the first end of the second rigid bar and the second end of the second rigid bar, wherein
the first end of the second rigid bar is attached to the vibration damping top plate through first passthrough opening of first rigid bar and
the second end of the second rigid bar is attached to the vibration damping top plate through second passthrough opening of first rigid bar, and
the first rigid bar and second rigid bar are surrounded by the flexible damping material between the first passthrough opening and the second passthrough opening.

5. The VDS of claim 4, wherein the first rigid bar and the second rigid bar are constructed of metal, plastic, wood, ceramic, or other rigid material.

6. The VDS of claim 4, wherein the flexible damping material includes a plurality of flexible rings or flexible balls, each having a passthrough orifice configured to freely pass the first rigid bar and the second rigid bar.

7. The VDS of claim 6, wherein the flexible damping material is constructed of plastic, rubber, or a gel.

8. The VDS of claim 4, wherein
a combination of the base damping member, top damping member, and flexible damping material are sandwiched between the vibration damping top plate and the vibration damping base plate and
the combination is configured to dampen vibration between the vibration damping base plate and the vibration damping top plate through the base damping member and the top damping member.

9. The VDS of claim 8, wherein
the vibration damping base plate includes a first plurality of slots and the vibration damping top plate includes a second plurality of slots,
the first plurality of slots is configured to receive a first plurality of outer portions of the flexible damping material when the first rigid bar is attached to the vibration damping base plate, and
the second plurality of slots is configured to receive a second plurality of outer portions of the flexible damping material when the second rigid bar is attached to the vibration damping top plate.

10. The VDS of claim 9, wherein the flexible damping material includes a plurality of flexible rings, each having a passthrough orifice configured to freely pass the first rigid bar and the second rigid bar,
wherein first plurality of slots and the second plurality of slots are configured into slots that receive two flexible rings per slot and hold the rings in a floating configuration.

11. The VDS of claim 9, wherein the vibration damping top plate includes a plurality of arms that extend outward from a central portion of the vibration damping top plate, wherein the second plurality of slots is arranged along the arms.

12. The VDS of claim 11, wherein
the vibration damping base plate includes a plurality of extending members that extend from a central portion of the vibration damping base plate,
the first plurality of slots is arranged along the extending members, and
each extending member corresponds to an arm of the vibration damping top plate.

13. The VDS of claim 12, wherein the vibration damping top plate includes at least four arms extending radially outward from the central portion of the vibration damping top plate.

14. The VDS of claim 12, wherein
the vibration damping top plate has a star-polygon shape where each arm of the plurality of arms extends outward from the central portion of the vibration damping top plate, and
the vibration damping base plate has a convex polygon shape that extends outward from the central portion of the vibration damping base plate.

15. The VDS of claim 12,
wherein the vibration damping top plate includes
a width of the vibration damping top plate,
a length of the vibration damping top plate that is longer than the width of the vibration damping top plate, and
an extended star-polygon shape where a portion of the arms of the plurality of arms extends outward from a plurality of central portions of the vibration damping top plate,
wherein the plurality of central portions of the vibration damping top plate is arranged along the length of the vibration damping top plate, and
wherein the vibration damping base plate includes
a width of the vibration damping base plate,
a length of the vibration damping base plate that is longer than the width of the vibration damping base plate, and
an extended convex polygon shape that extends outward from a plurality of central portions of the vibration damping base plate,
wherein the plurality of central portions of the vibration damping base plate is arranged along the length of the vibration damping base plate.

16. The VDS of claim 2,
wherein
the vibration damping base plate includes a passthrough orifice in a central portion of the vibration damping base plate, and
the vibration damping top plate is configured to be attached to the payload through the passthrough orifice of the vibration damping base plate, and
wherein the vibration damping top plate presses down on the vibration damping base plate when the vibration damping top plate is attached to the payload.

17. The VDS of claim 16, wherein the vibration damping base plate includes a plurality of quick release attachment devices that releasably attach the vibration damping base plate to the aerial vehicle allowing the combination of the VDS and the payload to be detached from the aerial vehicle.

18. The VDS of claim 17, wherein the plurality of quick release attachment devices is configured to autonomously detach the combination of the VDS and the payload from the aerial vehicle.

19. A method for damping vibration from an aerial vehicle to a payload utilizing a vibration damping system (VDS) for an aerial vehicle carrying a payload, the method comprising:
receiving a first vibration caused by the aerial vehicle at a vibration damping base plate attached to the aerial vehicle;
damping the first vibration with a damping device mechanically coupled to the vibration damping base plate and a vibration damping top plate attached to the payload to produce a damped second vibration; and
passing the damped second vibration to the vibration damping top plate through the damping device,
wherein
the damping device includes a flexible damping material and
the vibration damping base plate is physically isolated from the vibration damping top plate via the damping device.

20. The method of claim 19,
wherein damping the first vibration with the damping device includes passing the first vibration to a base damping member physically attached to the vibration damping base plate,
wherein passing the damping second vibration to the vibration damping top plate includes passing the damping second vibration to a top damping member physically attached to the vibration damping top plate, and
wherein
the base damping member is physically adjacent to the top damping member and
both the base damping member and the top damping member are partially surrounded by the flexible damping material.
